(19) United States
(12) Patent Application Publication
(10) Pub. No.: US 2026/0188745 A1
(43) Pub. Date: Jul. 2, 2026

(54) HIGH TEMPERATURE ELECTROLYTE FOR TEMPERATURE-DEPENDENT IN OPERANDO SALT CONCENTRATION MODIFICATION

(71) Applicant: Medtronic, Inc., Minneapolis, MN (US)

(72) Inventors: Laura E. McCalla, Brossard (CA); Lu Yu, Remond, WA (US); Marissa A. Caldwell, St. Paul, MN (US); Eric I. Hanson, Maple Grove, MN (US)

(21) Appl. No.: 19/130,624

(22) PCT Filed: Nov. 1, 2023
(86) PCT No.: PCT/IB2023/061008

§ 371 Date: May 16, 2025

Related U.S. Application Data
(60) Provisional application No. 63/427,209, filed on Nov. 22, 2022.

(51) Int. Cl. H01M 10/0568; H01M 10/0525; H01M 10/0569; H01M 10/42

(52) U.S. Cl. CPC H01M 10/0568; H01M 10/0525; H01M 10/0569; H01M 10/4235; H01M 2300/0037

(57) ABSTRACT

A battery including a total amount of lithium bis(oxalate)borate (LiBOB) such that a first amount of LiBOB is solid and a second amount of LiBOB is dissolved in an electrolyte when the battery is at application temperature, the first amount of LiBOB being a LiBOB reservoir. The battery also includes a housing and an electrode assembly. The electrode assembly includes a positive electrode, a negative electrode, a separator, and the electrolyte. The electrolyte includes the second amount of LiBOB.

This application claims the benefit of U.S. Provisional Patent Application Ser. No. 63/427,209, filed 22 Nov. 2022, the entire content of which is incorporated herein by reference.

### TECHNICAL FIELD

This disclosure generally relates to batteries. More specifically, the disclosure relates to batteries that may be exposed to elevated temperatures.

### BACKGROUND

For many battery-powered medical tools and devices, the ability to be both cordless and rechargeable is beneficial. For high-powered, high-energy applications, the use of lithium ion battery technology is particularly well suited for battery-powered medical equipment, such as surgical tools. To be safely used in an operating room, the battery-powered surgical tool must be sterile. In some cases, the surgical tool is sterilized without the battery followed by aseptic transfer of the battery into the sterile tool. These aseptic transfer methods require several people and a sterile field that must not be broken. In a different method, the battery-powered surgical tool containing the battery is sterilized using hydrogen peroxide gas plasma at low temperature (temperatures less than 50° C.). Although the battery-powered surgical tool can be sterilized with the battery already inserted, the hydrogen peroxide gas plasma method requires specialized equipment, such as a STERRAD instrument (available from Advanced Sterilization Products).

### SUMMARY

This disclosure describes a battery that includes a housing, a total amount of lithium bis(oxalate)borate (LiBOB), an electrode assembly, and a LiBOB reservoir all disposed within the housing. The total amount of LiBOB includes a first amount of LiBOB that is solid and a second amount of LiBOB that is dissolved in an electrolyte when the battery is at application temperature. The electrode assembly includes a positive electrode, a negative electrode, and a separator. In some embodiments, the separator includes a material having a degradation temperature of 120° C. or greater. The electrolyte includes a solvent and the second amount of LiBOB. In some embodiments, the solvent is an organic solvent. In some embodiments, the battery is capable of retaining 50% or more of its capacity upon exposure to a temperature of 100° C. or greater.

The present disclosure also describes a method of sterilizing batteries consistent with embodiments of the present disclosure. The method includes charging or discharging the battery to a state of charge of 20% to 100% at application temperature. The method further includes exposing the battery to a condition comprising a temperature of 100° C. or more for four minutes or more, wherein upon exposing the battery to the condition, the first amount of LiBOB decreases and the second amount of LiBOB increases.

The present disclosure further describes a method of forming batteries consistent with the present disclosure. The method includes disposing the electrode assembly and the total amount of lithium bis(oxalate)borate (LiBOB) within the housing. In some embodiments, the method further includes heating a solution to give a heated solution, the solution comprising the total amount of lithium bis(oxalate)borate, the organic solvent and the electrolyte. In some such embodiments, the solution is heated when disposed within the housing. In other such embodiments, the solution is heated external to the housing and the method further comprises, disposing the heated solution into the housing.

All scientific and technical terms have meanings commonly used in the art unless otherwise specified. The definitions provided are to facilitate understanding of certain terms used in the present disclosure.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

The term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range, including non-integers (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

The terms “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The term “room temperature” or “ambient temperature” refers to a temperature of 20° C. to 25° C.

The term “in the range” or “within a range” (and similar statements) includes the endpoints of the stated range.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the disclosure, guidance is provided through lists of examples, which examples may be used in various combinations. In each instance, the recited list serves only as a representative group and should not be interpreted as an exclusive or exhaustive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF DRAWINGS

FIG. 1A is a schematic cross-sectional view of a battery according to an embodiment.

FIG. 1B is a schematic cross-sectional view of an electrode assembly of the battery in FIG. 1A.

FIG. 2A is a schematic cross-sectional view of a battery at application temperature of an illustrative embodiment.

FIG. 2B is a schematic cross-sectional view of the battery of FIG. 2A directly after and/or during exposure to a high temperature.

FIG. 2C is a schematic cross-sectional view of the battery of FIG. 2B after being cooled to application temperature.

FIG. 3 is a flow diagram illustrating an overview of a method of using a battery according to embodiments of the present disclosure.

FIGS. 4A and 4B are flow diagrams illustrating an overview of methods of making a battery according to embodiments of the present disclosure.

FIG. 5 is a plot showing the normalized discharge capacity of various cells having various salt compositions after thermal cycles.

### DETAILED DESCRIPTION

The present disclosure generally relates to batteries. More specifically, the present disclosure relates to batteries that may be exposed to elevated temperatures while retaining a majority of their capacity.

Typical lithium ion batteries operate within the temperature range of −20° C. to 60° C., and exposure to temperatures outside that range may result in mechanical and/or electrochemical degradation of the battery. In some battery applications, it is desirable to temporarily subject lithium ion batteries to temperatures outside the −20° C. to 60° C. range. For example, it may be desirable to subject a lithium-ion battery powered medical equipment (e.g., medical device or tool) to temperatures greater than 60° C. to sterilize the equipment while the battery is operably coupled to the equipment. Many hospitals have autoclaves for sterilizing equipment. As such, it would be beneficial to make use of the autoclaves for sterilizing battery-powered surgical tools already having the battery disposed within. In order to achieve this goal, it is desirable that the lithium ion battery be able to withstand a standard steam autoclave cycle (e.g., 134° C. for 18 minutes) and maintain usability at application temperature (e.g., 10° C. to 45° C.) for 100 to 300 autoclave cycles. Thus, there is a need for batteries, such as lithium ion batteries, that can withstand high temperature conditions while maintaining their power output. Such batteries may be used in a variety of diagnostic tools, medical devices, and hand-held surgical tools that are commonly sterilized prior to use. Examples of such devices and tools include ultrasonic dissectors, vessel sealing devices, staplers, orthopedic saws and drills, radiofrequency powered surgical sealing devices, nerve integrity monitoring devices, ablation devices, powered atherectomy devices, pumps, implantable medical devices, wearable medical devices, and the like. In addition to medical equipment, batteries may be exposed to high temperatures in other applications. For example, batteries in equipment used for deep drilling operations may be exposed to temperatures up to 180° C. Besides special battery applications, consumer products having batteries may be intentionally or inadvertently exposed to high temperatures, for example, being left in a vehicle on a hot day. These exposures to extreme temperature may impact the performance of the battery.

The present disclosure describes batteries that are capable of surviving exposure to an elevated temperature (e.g., greater than 100° C.) for an exposure time of one minute or greater, while maintaining a high (e.g., at least 50%, at least 80%, at least 90%, or at least 95% of full) delivered power when subsequently used at their application temperature. In some embodiments, the batteries of the present disclosure are able to survive multiple rounds of exposure to temperatures greater than 100° C. for time lengths of one minute or greater. The term “surviving” is defined as delivering at least 50% of the battery's capacity at the application temperature as compared to the same battery before a single exposure to a temperature above 100° C. for a time length of one minute or greater. The term “application temperature” is the temperature at which the device in which the battery is inserted operates or is intended to operate. Application temperatures may range from 10° C. to 180° C. In the context of medical equipment, application temperature may range from 10° C. to 45° C. Such batteries can be subjected to high temperature sterilization, for example, through autoclaving.

Embodiments of the present disclosure may be applied to a primary battery, such as a lithium battery. Primary batteries are single use batteries that are not intended to be recharged. Embodiments of the present disclosure may be applied to a secondary battery, such as a lithium-ion battery. Secondary batteries are batteries that can be recharged and reused.

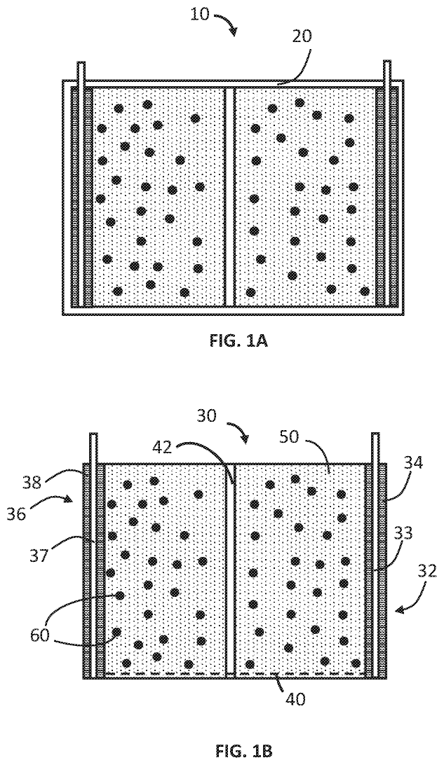

Turning to FIG. 1A-1B, an illustrative embodiment of a battery that includes one or more of the above-described features is depicted. FIG. 1A is a cross-sectional view of a battery 10. The battery 10 is generally configured to store electrical energy in the form of chemical energy. The battery 10 is also generally configured to supply electrical power to a device (e.g., a medical device, medical tool, surgical tool, or the like) to which it may be operably coupled (e.g., inserted in). FIG. 1A depicts the cross section of a cylindrical battery. The embodiments of the present disclosure may also be applied to many different battery configurations, such as a prismatic battery configuration, a button/coin battery configuration, or a pouch battery configuration. In some embodiments, the battery 10 is a lithium ion battery.

The battery 10 and the description of illustrative embodiments refer to a battery with a single cell. The term “cell” refers to a single voltaic/galvanic cell that includes an anode, a cathode, and an electrolyte. However, the embodiments of the present disclosure may be applied to a battery that includes two or more cells connected in series or in parallel.

Referring now to FIG. 1A, the battery 10 includes a housing 20. The housing 20 serves to contain the contents of the cell. In some embodiments, the housing 20 may be a conductive housing, that is, a housing at a non-neutral polarity. In such embodiments, the housing 20 is electrically conductive and may serve as an electrode or a current collector to complete the circuit of the battery. In some embodiments, the interior surface (the surface in contact with the electrode assembly), or a portion of the interior surface, of the housing may be coated with an insulative material. Coating at least a portion of the internal surface of the housing 20 with a insulative material may function to decrease the likelihood of or reduce housing corrosion and/or unwanted plating on the housing.

FIG. 1B is a cross-sectional view of the electrode assembly 30 of the battery 10 of FIG. 1A. The electrode assembly 30 includes an anode 32, a cathode 36, a separator 42, and an electrolyte 50. The electrode assembly 30 includes a total amount of lithium bis(oxalate)borate (LiBOB). A first portion of the LiBOB is dissolved in solution and is a part of the electrolyte 50. A second amount of LiBOB is a solid and forms a LiBOB reservoir 60.

The anode 32 is generally configured as a negative electrode. In some embodiments, the anode 32 includes an anode current collector 33. A current collector is made from and/or includes a conductive material and generally functions to operably couple the battery with an external circuit (e.g., allows the battery to provide power to the device/tool in which it is operably coupled). An anode current collector 33 allows for the transportation of electrons from the anode to the external circuit. The anode current collector 33 may be made of any suitable anode current collector material. Non-limiting examples of anode current collector materials include copper, aluminum, titanium, carbon, and combinations thereof. In some embodiments, the anode current collector 33 includes copper. In some embodiments the housing 20 is at least partially conductive and at a negative polarity, and serves as the anode current collector 33. The anode current collector 33 may be of any suitable configuration. Examples of suitable anode current collector configurations include a foil, a mesh, a foam, an etched surface, and combinations thereof.

In some embodiments, at least a portion of the anode current collector 33 is surface treated (e.g., coated). Non-limiting examples of surface treatments include carbon coatings; copper coatings; nitride coatings (e.g., nitridization); oxide coatings that include copper, aluminum, titanium, carbon, or combinations thereof; or any combination thereof. In some embodiments, at least a portion of the anode current collector 33 is surface treated with a positive temperature coefficient material. A positive temperature coefficient material is a material that has an increase in electrical resistance when exposed to increased temperatures. Examples of positive temperature coefficients include carbon black mixed in a polymer matrix. The polymer matrix may include any suitable polymer. In some embodiments, the polymer matrix may include polypropylene.

The anode 32 may include an anode active material 34. The anode active material 34 is a material that participates in the oxidation reaction at the anode 32 during discharge. The anode active material 34 is in electrical contact (directly and/or through a conductive material such as a conductive compound) with at least a portion of the anode current collector 33.

In some embodiments the anode active material 34 includes lithium. The lithium may be in the form of metallic lithium; lithium intercalating material such as carbon containing materials (e.g., graphite); a metal-alloy containing material capable of intercalating lithium; lithium titanate (e.g., lithium titanium oxide, Li₄Ti₅O₁₂); a lithium alloy such as lithium-aluminum, lithium-silicon, lithium-bismuth, lithium-cadmium, lithium-magnesium, lithium-tin, lithium-antimony, lithium-germanium, lithium-lead, oxides thereof, sulfides thereof, phosphides thereof, carbides thereof, nitrides thereof; or a combination thereof. In some embodiments, the anode active material 34 includes metallic lithium, lithium and carbon containing materials, lithium titanium oxide, or any combination thereof.

In some embodiments, the anode active material 34 includes a lithium titanium oxide. In some embodiments, the lithium titanium oxide includes a compound of the general formula Li₄MₓTi₅₋ₓO₁₂; where M is a metal selected from aluminum, magnesium, nickel, cobalt, iron, manganese, vanadium, copper, chromium, molybdenum, niobium, and combinations thereof, and 0≤x≤1. In some embodiments, the lithium titanium oxide includes Li₂Ti₃O₇; Li₄Ti_{4.75}V_{0.25}O₁₂; Li₄Ti_{4.75}Fe_{0.25}O_{11.88}; Li₄Ti_{4.5}Mn_{0.5}O₁; or a combination thereof. In some embodiments, the lithium titanium oxide includes a compound of the general formula LiM′M″XO₄; where M′ is a metal selected from nickel, cobalt, iron, manganese, vanadium, copper, chromium, molybdenum, niobium, and combinations thereof; M″ is a three valent non-transition metal; and X is a metal selected from zirconium, titanium, and combinations thereof.

In some embodiments, the lithium titanium oxide includes lithium titanate. Lithium titanates are compounds consisting of lithium, titanium, and oxygen. In some embodiments, the lithium titanium oxide includes lithium titanate of the general formula LiₓTi_{y}O₄; where x is 0≤x≤4; and y is 0≤y≤2. In some embodiments, the lithium titanate is used in any state of lithiation and may include, for example, a compound of the general formula Li₄₊ₓTi₅O₁₂; where 0≤x≤3. In some embodiments the lithium titanate is Li₂TiO₃; Li₄Ti₅O₁₂ (also called Li₁₊ₓ[Li_{1/3}Ti_{5/3}]O₄ where 0≤x<1); Li₄TiO₄; or a combination thereof.

In some embodiments, the anode active material 34 includes a carbon-containing material capable of intercalating lithium. Examples of carbon-containing materials capable of intercalating lithium include natural graphite, artificial graphite (e.g., mesocarbon microbead), graphene, carbon nanotubes, carbon black, and combinations thereof.

In some embodiments, the anode active material includes a polymer.

In some embodiments, the anode active material 34 includes a metal-alloy containing material capable of intercalating lithium. Examples of metal-alloy containing materials capable of intercalating lithium include silicon-containing materials and tin-containing materials.

In some embodiments, the anode 32 includes one or more additional anode additives. In some such embodiments, the anode additive includes a positive temperature coefficient material.

In some embodiments, the anode 32 includes a conductive carbon additive. The conductive carbon additive is electrically conductive. Conductive carbon additives generally do not intercalate lithium. The conductive carbon additive may enhance the electrochemical performance of the anode 32 and/or the anode active material 34. Examples of conductive carbon additives include natural graphite, artificial graphite (e.g., mesocarbon microbead), graphene, carbon nanotubes, carbon black, and combinations thereof.

In some embodiments, the anode 32 includes an anode binder. The anode binder allows for the physical connection and/or electrical connection of one or more components (e.g., anode active material, anode current collector, anode additives) of the anode 32. Any suitable anode binder may be used. Examples of suitable anode binders include carboxy methyl cellulose (CMC), styrene-butadiene rubber (SBR), polyvinylidene fluoride (PVDF), polytetrafluoroethylene (PTFE), and combinations thereof. In certain embodiments, the anode binder includes PVDF.

The anode has an anode total dry weight. The anode total dry weight is the sum of the weight of the anode active material; the weight of the binder (if included in the anode); and the weight of any anode additives (if included in the anode). The total dry anode weight does not include the weight of the current collector or any solvents.

In embodiments where the anode 32 includes a conductive carbon additive, the anode includes 0.1 wt-% or more of the conductive carbon additive based on the anode total dry weight. In some embodiments, the anode 32 includes 10 wt-% or less of the conductive carbon additive based on the anode total dry weight. In some embodiments, the anode 32 includes 0.1 wt-% to 10 wt-%, 0.1 wt-% to 5 wt-%, 4 wt-% to 10 wt-%, or 5 wt-% to 8 wt-% of the conductive carbon additive based on the anode total dry weight.

In embodiments where the anode 32 includes one or more anode additives, the anode includes 0.1 wt-% or more of the total amount of the one or more anode additives based on the anode total dry weight. In some embodiments, the anode 32 includes 10 wt-% or less of the one or more anode additives based on the anode total dry weight. In some embodiments, the anode includes 0.1 wt-% to 10 wt-%, 0.1 wt-% to 5 wt-%, 4 wt-% to 10 wt-%, or 5 wt-% to 8 wt-% of the one or more anode additives based on the anode total dry weight.

In embodiments where the anode 32 includes an anode binder, the anode includes 0.1 wt-% or more of the anode binder based on the anode total dry weight. In some embodiments, the anode 32 includes 10 wt-% or less of the anode binder based on the anode total dry weight. In some embodiments, the anode includes 0.1 wt-% to 10 wt-%, 0.1 wt-% to 5 wt-%, 4 wt-% to 10 wt-%, or 5 wt-% to 8 wt-% of the anode binder based on the anode total dry weight.

The electrode assembly 30 of the battery 10 includes a cathode 36. The cathode 36 is generally configured as the positive electrode. In some embodiments, the cathode 36 includes a cathode current collector 37. The cathode current collector 37 allows for the transportation of electrons from an external circuit (e.g., the device/tool to which the battery is operably coupled) to the cathode. The cathode current collector 37 may be made of and/or include any suitable current collector material. Examples of suitable cathode current collector material include aluminum, titanium, titanium nitride, metalized polymers (e.g., polymers that include a metal, for example as a coating), carbon, nickel, stainless steel, and combinations thereof. In some embodiments, the cathode current collector material includes aluminum.

The cathode current collector 37 may be of any suitable configuration. Examples of suitable cathode current collector configurations include a foil, a mesh, a foam, an etched surface, or combinations thereof. In some embodiments, the cathode current collector material includes an aluminum foil.

In some embodiments, at least a portion of the cathode current collector 37 is surface treated (e.g., coated). In some embodiments, the cathode current collector surface treatment includes a carbonaceous compound. Examples of carbonaceous compound cathode current collector surface treatments include natural graphite, artificial graphite (e.g., mesocarbon microbead), and carbon black. In some embodiments, the cathode current collector surface treatment includes a nano-scale carbon compound. Examples of nano-scale carbon compounds suitable for cathode current collector surface treatment include graphene, carbon nanotubes, and other carbon nano-scale coating such as those disclosed in U.S. Pat. No. 9,172,085. The use of nano-scale carbon surface treatments may allow for the use of less surface treatment material than non-nano-scale carbon surface treatments due to the larger surface area of the nano-scale carbon material as compared to non-nano-scale carbon materials.

In some embodiments, the cathode current collector 37 includes aluminum and at least a portion of the aluminum cathode current collector is surface treated. In some embodiments, the cathode current collector 37 includes aluminum and at least a portion of the aluminum cathode current collector is surface treated with a carbonaceous compound. In some embodiments, the cathode current collector 37 includes aluminum and at least a portion of the aluminum cathode current collector is surface treated with conductive carbon such as carbon nanotubes, graphene or graphene-like carbon, or a combination thereof.

In certain embodiments, at least a portion of the cathode current collector 37 is surface treated with a positive temperature coefficient material. In some such embodiments, the positive temperature coefficient material is designed to raise the cell impedance at temperatures above 135° C.

In some embodiments, the cathode 36 includes a cathode active material 38. The cathode active material 38 is the material that participates in the reduction reaction. In some embodiments the cathode active material includes a lithium-containing metal oxide, a lithium-containing metal phosphate, or both. Examples of lithium-containing metal oxides include lithium cobalt oxide (e.g., LiCoO₂), lithium manganese oxide (e.g., LiMn₂O₄), lithium nickel manganese cobalt oxide (e.g., Li(NiMnCo)O₂), lithium nickel oxide (e.g., LiNiO₂), lithium nickel cobalt aluminum oxide (e.g., Li(NiCoAl)O₂), and combinations thereof. Examples of lithium-containing metal phosphates include lithium iron phosphate (e.g., LiFePO₄) and lithium iron cobalt phosphate (LiFeₓCo₍₁₋ₓ₎PO₄; x=0.2, 0.5, 0.8, or 1). In some embodiments, the cathode active material 38 includes LiFePO₄, Li(NiCoAl)O₂, LiCoO₂, or any combination thereof.

In some embodiments, at least a portion of the cathode active material 36 is surface treated. In some embodiments, the cathode active material surface treatment includes a metal oxide (e.g., Al₂O₃), a metal phosphate (e.g., LaPO₄), a metal halide, carbon, or a combination thereof. In some embodiments, the cathode active material surface treatment includes a positive temperature coefficient material. In some embodiments, the cathode active material is a lithium-containing metal oxide that is surface treated.

In some embodiments, the cathode 36 includes one or more cathode additives. The cathode additive may be incorporated into the bulk of the cathode active material. In some such embodiments, the one or more cathode additives includes a positive temperature coefficient material. For example, the cathode additive may include carbon black mixed in a polymer matrix.

In some embodiments, the cathode 36 includes a conductive carbon additive. The conductive carbon additive is electrically conductive and may serve to enhance the electrochemical performance of the cathode 36 and/or the cathode active material 38. Examples of conductive carbon additives include natural graphite, artificial graphite (e.g., mesocarbon microbead), graphene, carbon nanotubes, carbon black, and combinations thereof.

In some embodiments, the cathode 36 includes a cathode binder. The cathode binder allows for the physical connection and/or electrical connection of two or more parts of the cathode (e.g., cathode current collector 37, cathode active material 38, and any cathode additives). Any suitable binder may be used, such as carboxy methyl cellulose (CMC), styrene-butadiene rubber (SBR), polyvinylidene fluoride (PVDF), polytetrafluoroethylene (PTFE), or a combination thereof. In certain embodiments, the cathode binder includes PVDF.

The cathode 36 has a cathode total dry weight. The cathode total dry weight is the sum of the weight of the cathode active material; the weight of the cathode binder (if included in the cathode); and the weight of any cathode additives (if included in the cathode). The total cathode dry weight does not include the weight of the cathode current collector or any solvents.

In embodiments where the cathode 36 includes conductive carbon, the cathode includes 0.1 wt-% or more of the conductive carbon based on the cathode total dry weight. In some embodiments, the cathode includes 10 wt-% or less of the conductive carbon based on the cathode total dry weight. In some embodiments, the cathode includes 0.1 wt-% to 10 wt-%, 0.1 wt-% to 5 wt-%, 4 wt-% to 10 wt-%, or 5 wt-% to 8 wt-% of the conductive carbon based on the cathode total dry weight.

In embodiments where the cathode 36 includes one or more cathode additives, the cathode includes 0.1 wt-% or more of the total amount of the one or more cathode additives based on the cathode total dry weight. In some embodiments, the cathode includes 10 wt-% or less of the one or more cathode additives based on the cathode total dry weight. In some embodiments, the cathode includes 0.1 wt-% to 10 wt-%, 0.1 wt-% to 5 wt-%, 4 wt-% to 10 wt-%, 5 wt-% to 8 wt-% of the one or more cathode additives based on the cathode total dry weight.

In embodiments where the cathode 36 includes a cathode binder, the cathode includes 0.1 wt-% or more of the cathode binder based on the cathode total dry weight. In some embodiments, the cathode includes 10 wt-% or less of the cathode binder based on the cathode total dry weight. In some embodiments, the cathode includes 0.1 wt-% to 10 wt-%, 0.1 wt-% to 5 wt-%, 4 wt-% to 10 wt-%, 5 wt-% to 8 wt-% of the cathode binder based on the cathode total dry weight.

The electrode assembly 30 of the battery 10 includes a separator 42. The separator 42 is generally configured to inhibit direct interaction between the cathode 36 and the anode 32, thus limiting the likelihood of internal short circuits. The separator is also generally configured to allow for the transport of ions between the cathode 36 and the anode 32. The separator 42 is located in the interelectrode region 40. The interelectrode region 40 is the entire volume of the cell not occupied by the cathode 36 or the anode 32. The interelectrode region 40 includes any pores within the cathode 36 and/or the anode 32. In some embodiments, the separator 42 may be in physical contact with one or both of the electrodes.

To allow for the transport of ions between the anode 32 and the cathode 36, the separator 42 is generally porous. At least some of the pores of the separator 42 are permeable, that is, they allow the ions to flow from one side of the separator 42 to the other side of the separator 42.

The separators included in the batteries of the present disclosure may be designed to withstand multiple exposures to temperatures of greater than 100° C. with little to no degradation. Not wishing to be bound by theory, it is thought that the separator may not need to include a material that has a degradation temperature degradation temperature equal to or greater than the highest temperature that the battery is intended to be exposed to. The term “degradation temperature” is the temperature at which a material is no longer mechanically and/or chemical stable. In some embodiments, the degradation temperature is the melting temperature of the material. It is thought that although the battery may be exposed to a certain high exposure temperature, the separator within the battery may be at least partially insulated and as such, reach a lower temperature than the exposure temperature.

In some embodiments, the separator includes two or more layers. The two or more layers may be bound together (e.g., laminated), to from a single multi-layer composite separator. Each layer of a composite separator may have the same degradation temperature. Each a layer of the composite separator may have different degradation temperature. Two or more of the layers of the separator may have the same degradation temperature while one or more other layers may have different degradation temperatures.

In some embodiments, the separator 42 includes one or more layers that have a degradation temperature of 100° C. or greater, preferably 125° C. or greater. In some embodiments, the separator includes one or more layers that have a degradation temperature of 100° C. or greater, 125° C. or greater, 135° C. or greater, 150° C. or greater, 160° C. or greater, 170° C. or greater, 180° C. or greater, or 200° C. or greater. There is no desired upper limit to the degradation temperature of a layer included in a separator; however, in practice, the separator may include one or more layers having a degradation temperature of 300° C. or less. In embodiments, the separator includes one or more materials having a degradation temperature of 100° C. to 300° C., 125° C. to 300° C., 150° C. to 300° C., or 180° C. to 300° C.

In certain embodiments, multiple separator layers may be used, each of which may have a melting point 100° C. or greater, preferably 125° C. or greater. In some embodiments, one or more of the layers of a composite separator may have a lower degradation temperature such that it melts when exposed to an elevated temperature. Such a layer sandwiched between two or more layers that have degradation temperatures above the elevated exposure temperature may serve the purpose of a shutdown separator. For example, a composite separator may include three layers. The inner layer may have a degradation temperature that is lower than the anticipated elevated temperature that the battery and/or separator will be exposed to. The two outer layers may have degradation temperatures that are greater than the anticipated elevated exposure temperature that the battery and/or separator will be exposed to. Upon exposure of the battery to an elevated exposure temperature, the inner layer of the composite separator may melt, preventing ion flow in the battery while maintaining the separation between the anode and the cathode. An example of such a composite separator configuration includes a separator that has an inner layer material with a degradation temperature of approximately 130° C. and two outer layers having a degradation temperature 200° C. or greater. Such separators may include a polyethylene inner layer and polypropylene outer layers such as the separators available from CELGARD (Charlotte, NC) under the trade name CELGARD TRILAYER PP/PE/PP.

The separator 42 may include any suitable separator material. Examples of suitable separator materials include, polymeric porous membranes such as polyethylene, polypropylene, polyterephthalate, polyimide, cellulose based polymers and combinations thereof; modified polymeric membranes with thin oxide coatings of titania (TiO₂), zinc oxide (ZnO), silica (SiO₂), and combinations thereof; and hybrid organic-organic assemblies such as those that contain SiO₂ nanoparticles covalently tethered within a polymeric network such as polyurethanes, polyacrylates, polyethylene glycol; and combinations thereof.

In some embodiments, the separator material is a material that has a degradation temperature of 125° C. or greater. Examples of such materials include polyimides, polyolefins (e.g., polypropylene), polyethylene terephthalate, ceramic-coated polymer (e.g., ceramic coated polypropylene and ceramic coated polyethylene), cellulose, and combinations thereof. Such materials may be in the form in microfibers, nanofibers, or both. In some embodiments, the separator includes a combination of microfibers and nanofibers. In some embodiments, the separator includes polyethylene terephthalate microfibers and cellulose nanofibers. Examples of such separators are disclosed in U.S. Pat. No. 8,936,878 and are available from Dreamweaver International (in Greer, SC) under the tradename SILVER, TITANIUM, and GOLD.

Examples of separator materials that have a degradation temperature of 200° C. or greater include polyimide, polyethylene terephthalate, cellulose, aramid fibers, ceramics, and combinations thereof.

In some embodiments, the separator may be surface treated. In some embodiments, one or more layers of a composite separator may be surface treated. Example surface treatments include ceramics such as aluminum oxides (e.g., Al₂O₃) and silicon oxides (SiOₓ).

According to an embodiment, the electrode assembly 30 includes lithium bis(oxalate)borate (LiBOB). The electrode assembly 30 includes a total amount of lithium bis(oxalate)borate (LiBOB). The total amount of LiBOB is contained within the interelectrode region 40. The total amount of LiBOB is supersaturating under given conditions such that at application temperature the battery has a first amount of LiBOB and a second amount of LiBOB that are in different physical states. The first amount of LiBOB is dissolved within the electrolyte solution, and therefore is a part of the electrolyte 50. The terms “electrolyte” and “electrolyte solution” are used interchangeably here to mean a homogenous solution that includes one or more solvents, one or more salts (including at least LiBOB), and in some cases, one or more electrolyte additives. Precipitates of salts and/or additives that are in contact (e.g., dispersed within the electrolyte) with the electrolyte are not considered a part of the electrolyte. The second amount of LiBOB is a precipitate that is in a solid form. Although contacting the electrolyte solution (e.g., dispersed within the electrolyte solution), the second amount of LiBOB is not dissolved within the electrolyte and is not a part of the electrolyte. The second amount of LiBOB is a LiBOB reservoir 60. Stated differently, the total amount of LiBOB is beyond the saturation point in a given electrolyte solution at the application temperature of the battery.

The total amount of LiBOB is not constant throughout the life of a battery.

Throughout the lifetime of the battery, a portion of the LiBOB that is a part of the electrolyte (the first amount of LiBOB) will be consumed. To maintain equilibrium, a portion of the LiBOB reservoir 60 (the second amount of LiBOB) dissolves to become a part of the electrolyte thereby replenishing the amount of the first portion of LiBOB consumed. As such, the LiBOB reservoir 60 may act as a LiBOB feedstock to supply additional amounts of LiBOB into the electrolyte. The batteries of the present disclosure include a total amount of LiBOB that is supersaturating at application temperature throughout the lifetime of the battery. As LiBOB is consumed the total amount of LiBOB remains supersaturated at application temperature. The LiBOB reservoir 60 may advantageously allow for the first amount of LiBOB to remain relatively constant at the application temperature throughout the life of the battery.

The solubility limit of LiBOB in an electrolyte is dependent on a variety of factors including at least on the temperature, the total salt concentration, the identity of any additional salts, the identity and amount of any electrolyte additives, and the identity of the electrolyte solvent or mixture of solvents in which the total amount of LiBOB is disposed. To determine the solubility limit of LiBOB under a given set of factors, one can increase the concentration of LiBOB under the given factors until a solid particulate is observed, that is, at least a portion of the LiBOB added to the mixture is not dissolving into the electrolyte. This concentration of LiBOB added to reach this point is the saturation point (i.e., the saturation concentration) of LiBOB for the given set of factors.

The total amount of LiBOB in the cell is greater than the saturation concentration of LiBOB under a given set of conditions. The total amount of LiBOB in the cell is a supersaturating amount at the application temperature of the battery (i.e., there is a portion of LiBOB that is in solution and a portion of LiBOB that is a precipitate). The total amount of LiBOB includes the amount of LiBOB that is dissolved (i.e., that is a part of the electrolyte) and the amount of LiBOB that is a precipitate (i.e., that is the LiBOB reservoir). Said differently, the total amount of LiBOB is the total amount of LiBOB in the battery. When stated in terms of a molar quantity, the total amount of LiBOB includes both the LiBOB that is dissolved in solution and the LiBOB that is a precipitate. The molar quantity of the total amount of LiBOB is based on the volume of the electrolyte. In some embodiments, the total amount of LiBOB is 0.05 M or greater, 0.1 M or greater, 0.2 M or greater, 0.3 M or greater, 0.4 M or greater, 0.5 M or greater 0.6 M or greater, 0.7 M or greater, 0.8 M or greater, or 0.9 M or greater. In some embodiments, the total amount of the LiBOB is 1 M or less, 0.9 M or less, 0.8 M or less, 0.7 M or less, 0.6 M or less, 0.5 M or less, 0.4 M or less, 0.3 M or less, 0.2 M or less of 0.1 M or less. In some embodiments, the total amount of LiBOB is 0.05 M to 1 M, 0.05 M to 0.9 M, 0.05 M to 0.8 M, 0.05 M to 0.7 M, 0.6 M, 0.05 M to 0.5 M, 0.05 M to 0.4 M, 0.05 M to 0.3 M, 0.05 M to 0.2 M, or 0.05 M to 0.1 M. In some embodiments, the total amount of LiBOB is 0.1 M to 1 M, 0.1 M to 0.9 M, 0.1 M to 0.8 M, 0.1 M to 0.7 M, 0.1 M to 0.6 M, 0.1 M to 0.5 M, 0.1 M to 0.4 M, 0.1 M to 0.3 M, or 0.1 M to 0.2 M. In some embodiments, the total amount of LiBOB is 0.2 M to 1 M, 0.2 M to 0.9 M, 0.2 M to 0.8 M, 0.2 M to 0.7 M, 0.2 M to 0.6 M, 0.2 M to 0.5 M, 0.2 M to 0.4 M, or 0.2 M to 0.3 M. In some embodiments, the total amount of LiBOB at the application temperature is 0.3 M to 1 M, 0.3 M to 0.9 M, 0.3 M to 0.8 M, 0.3 M to 0.7 M, 0.3 M to 0.6 M, 0.3 M to 0.5 M, or 0.3 M to 0.4 M. In some embodiments, the total amount of LiBOB is 0.4 M to 1 M, 0.4 M to 0.9 M, 0.4 M to 0.8 M, 0.4 M to 0.7 M, 0.4 M to 0.6 M, or 0.4 M to 0.5 M. In some embodiments, the total amount of LiBOB is 0.5 M to 1 M, 0.5 M to 0.9 M, 0.5 M to 0.8 M, 0.5 M to 0.7 M, or 0.5 M to 0.6 M. In some embodiments, the total amount of LiBOB is 0.6 M to 1 M, 0.6 M to 0.9 M, 0.6 M to 0.8 M, or 0.6 M to 0.7 M. In some embodiments, the total amount of LiBOB is 0.7 M to 1 M, 0.7 M to 0.9 M, or 0.7 M to 0.8 M. In some embodiments, the total amount of LiBOB is 0.8 M to 1 M or 0.8 M to 0.9 M. In some embodiments, the total amount of LiBOB at the is 0.9 M to 1 M.

The temperature of the electrolyte impacts the solubility of LiBOB. When the temperature of the electrolyte increases, the saturation concentration of LiBOB increases. As such, exposing the battery 10 to an elevated temperature (e.g., above 100° C.) may increase the temperature of the electrolyte thereby increasing the saturation concentration of LiBOB. Therefore, exposing the battery to an elevated temperature may cause at least a portion of the LiBOB reservoir 60 (i.e., at least a portion of the second amount of LiBOB) to dissolve into the electrolyte 50 thereby increasing the first amount of LiBOB and decreasing the second amount of LiBOB relative to the amounts present at application temperature. Subsequently cooling the battery from the elevated temperature, may again change the saturation concentration of LiBOB, such as decreasing the saturation concentration. As such, cooling the cell back to application temperature may result in at least a portion of the first amount of LiBOB precipitating out of the electrolyte 50 to become a part of the LiBOB reservoir 60 (i.e., the second amount of LiBOB). As such, the second amount of LiBOB increases and the first amount of LiBOB decreases relative to the amounts present at the elevated temperature.

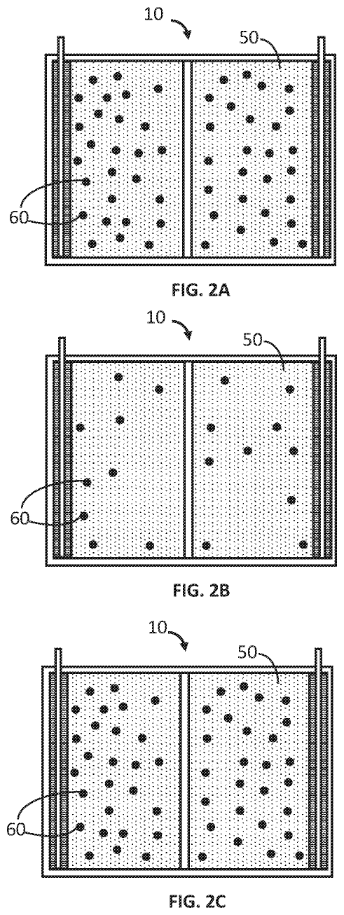

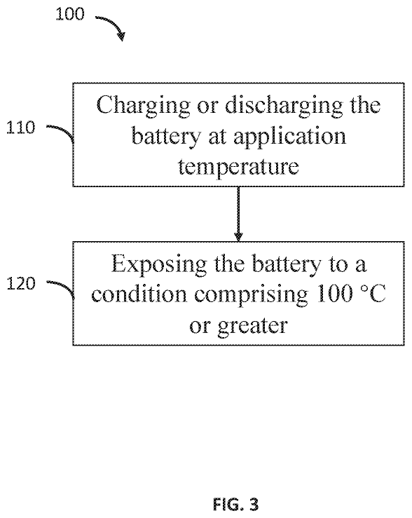

FIGS. 2A-2C schematically show how the first amount of LiBOB and second amount of LiBOB may change through exposure of the illustrative battery 10 of FIG. 1A to various temperatures. FIG. 2A shows the battery 10 at application temperature. At application temperature, the electrolyte 50 includes a first amount of LiBOB that is dissolved in the electrolyte (e.g., is a part of the electrolyte). The battery 10 also includes a second amount of LiBOB disposed within the electrolyte 50 but not a part of the electrolyte. The second amount of LiBOB is a precipitate and is a LiBOB reservoir 60. Although the LiBOB reservoir 60 is depicted as dispersed within the electrolyte, the LiBOB reservoir may be a conglomeration of LiBOB particles. Portions of the LiBOB reservoir 60 may be located anywhere and/or multiple locations within the battery 10. For example, at least a portion of the LiBOB reservoir 60 may be located within the interelectrode region 40. A portion of the LiBOB reservoir 60 may be intercalated within the anode and/or cathode active materials. FIG. 2B shows the state of the LiBOB when the battery 10 is held at an elevated temperature and/or for a portion of time before and/or after (e.g., when the battery is expose to a temperature that is near the elevated temperature such as when the battery is heating up to and/or cooling down) the battery 10 has been exposed to an elevated temperature. A portion of the LiBOB reservoir 60 has dissolved into the electrolyte 50 thereby increasing the first amount of LiBOB and decreasing the second amount of LiBOB. In some embodiments, the total amount of LiBOB and/or the temperature of exposure allow for all of the LiBOB reservoir 60 to completely dissolve into the electrolyte when the battery is exposed to an elevated temperature. In such cases, the second amount of LiBOB is zero and the first amount of LiBOB is equal to the total amount of LiBOB when the battery is at the elevated temperature. FIG. 2C shows the state of the LiBOB after the battery 10 of FIG. 2B is cooled back to application temperature. Upon cooling, the saturation concentration shifts such that at least a portion of the first amount of LiBOB in FIG. 2B precipitates and becomes a part of the LiBOB reservoir 60.

Employing a total amount of LiBOB that is supersaturating under a given set of conditions while at application temperature, may afford certain advantages. For example, in some embodiments, a supersaturating amount of LiBOB may contribute to the mechanical and/or electrochemical stability of the battery upon routine exposure of the battery to elevated temperatures (e.g., 100° C. or greater). Although not wishing to be bound by theory, it is thought that the increased amount of the first amount of LiBOB that is a result of heating the battery to increase the saturation concentration of LiBOB may serve to protect the current collectors and/or electrodes from degradation at high temperatures. In some embodiments, a supersaturating amount of LiBOB may allow for improved application temperature power capability after routine exposure of the battery to elevated temperatures (e.g., 100° C. or greater) when compared to the same battery without a supersaturating amount of LiBOB. Throughout the lifetime of the battery, LiBOB is consumed. As such, in some embodiments the LiBOB reservoir allows for the replenishment of at least a portion of the first amount of LiBOB.

The electrode assembly 30 of the battery 10 includes an electrolyte 50. The electrolyte 50 may occupy any or all of the interelectrode region 40. The electrolyte may intercalate the anode and/or cathode. The electrolyte 50 physically contacts the anode 32, the cathode 36, and the separator 42. At least one salt included in the electrolyte 50 is LiBOB, more specifically, the first amount of LiBOB. Precipitated LiBOB forms the reservoir 60. Some or all of the reservoir 60 may be dispersed throughout the electrolyte 50. Some or all of the reservoir 60 may agglomerate and/or settle at the bottom of the battery 10, and thus not be dispersed throughout the electrolyte 50.

In some embodiments, the electrolyte includes one or more additional salts. In some embodiments, the one or more additional salts may be employed in a supersaturating amount to create a reservoir similar to reservoir of LiBOB. In some embodiments, the one or more additional salts are employed at concentrations below their respective saturation points at the application temperature. In such embodiments, the salts are dissolved into their component ions and are a part of the electrolyte. Examples of additional salts that may be used include lithium bis(trifluoromethanesulfonimide) (LiTFSI); lithium difluoro(oxalato)borate (LiDFOB); lithium bis(pentafluoroethyl sulfonyl)imide (LiBETI); lithium bis(fluorosulfonyl)imide (LiFSI), lithium difluoro(oxalate)borate (LiDFOB); lithium tetrafluoroborate (LiBF₄); bis(perfluoroethanesulfonyl)imide (LiPFSI or LiBETI); lithium-cyclo-difluoromethane-1,1-bis(sulfonyl)imide (LiDMSI); lithium trifluoromethanesulfonate (lithium triflate); lithium fluoroalkyphosphate (LiFAP); lithium-cyclo-hexafluoropropane-1,1-bis(sulfonyl)imide (LiHPSI); lithium hexafluoroarsenate (LiAsF₆); lithium hexafluorophosphate (LiPF₆); lithium dicyano-trifluoromethyl-imidazole (LiTDI); lithium bis(fluoromalonato)borate (LiNFMB); dilithium tetracyanoborate; lithium dicyanotriazlate (LiDCTA); cyano-pentafluoroethyl-imidazole; lithium perchlorate; and combinations thereof.

In some embodiments, the one or more additional salts is included in an amount of 0.01 M or greater, 0.1 M or greater, 0.2 M or greater, 0.3 M or greater, 0.4 M or greater, 0.5 m or greater, 1 M or greater, 2 M or greater, 3 M or greater, 4 M or greater, or 5 M or greater. In some embodiments, the one or more additional salts is included in an amount of 6M or less, 5 M or less, 4 M or less, 3M or less, 2 M or less, 1 M or less, 0.5 M or less, or 0.1 M or less. In some embodiments, the one or more additional salts is included in an amount of 0.01 M to 6 M, 0.01 M to 5 M, 0.01 M to 4 M, 0.01 M to 3 M, 0.01 M to 2 M, 0.01 M to 1 M, 0.01 M to 0.5 M, or 0.01 M to 0.1 M. In some embodiments, the one or more additional salts is included in an amount of 0.1 M to 6 M, 0.1 M to 5 M, 0.1 M to 4 M, 0.1 M to 3 M, 0.1 M to 2 M, 0.1 M to 1 M, or 0.1 M to 0.5 M. In some embodiments, the one or more additional salts is included in an amount of 0.5 M to 6 M, 0.5 M to 5 M, 0.5 M to 4 M, 0.5 M to 3 M, 0.5 M to 2 M, or 0.5 M to 1 M. In some embodiments, the one or more additional salts is included in an amount of 1 M to 6 M, 1 M to 5 M, 1 M to 4 M, 1 M to 3 M, or 1 M to 2 M. In some embodiments, the one or more additional salts is included in an amount of 2 M to 6 M, 2 M to 5 M, 2 M to 4 M, or 2 M to 3 M. In some embodiments, the one or more additional salts is included in an amount of 3 M to 6 M, 3 M to 5 M, or 3 M to 4 M. In some embodiments, the one or more additional salts is included in an amount of 4 M to 6 M or 4 M to 5 M. In some embodiments, the one or more additional salts is included in an amount of 5 M to 6 M.

The battery has a total amount of salt. The total amount of salt is the sum of the total amount of LiBOB and the amount of any additional salts. The molar quantity of the total amount salt is based on the volume of the electrolyte. In some embodiments, the total amount of salt is 0.01 M or greater, 0.5 M or greater, 1 M or greater, 2 M or greater, 3 M or greater, 4 M or greater, or 5 M or greater. In some embodiments, the total amount of salt is 6 M or less, 5 M or less, 3 M or less, 2 M or less, 1 M or les, or 0.5 M or less. In some embodiments, the total amount of salt is 0.01 M to 6 M, 0.01 M to 5 M, 0.01 M to 4 M, 0.01 M to 3 M, 0.01 M to 2 M, 0.01 M to 1 M, or 0.01 M to 0.5 M. In some embodiments, the total amount of salt is 0.5 M to 6 M, 0.5 M to 5 M, 0.5 M to 4 M, 0.5 M to 3 M, 0.5 M to 2 M, or 0.5 M to 1 M. In some embodiments, the total amount of salt t is 1 M to 6 M, 1 M to 5 M, 1 M to 4 M, 1 M to 3 M, or 1 M to 2 M. In some embodiments, the total amount of salt is 2 M to 6 M, 2 M to 5 M, 2 M to 4 M, or 2 M to 3 M. In some embodiments, the total amount of salt is 3 M to 6 M, 3 M to 5 M, or 3 M to 4 M. In some embodiments, the total amount of salt is 4 M to 6 M or 4 M to 5 M. In some embodiments, the total amount of salt is 5 M to 6 M. In some embodiments, the battery has a total amount of salt that is 0.5 M to 1.5 M.

Generally, the use of LiPF₆ alone in an electrolyte may result in rapid mechanical and/or electrochemical degradation of the battery when exposed to elevated temperatures. In some embodiments, the battery includes 25 mol-% or less of LiPF₆ of the total salt amount, if any. In some embodiments, the battery has a total salt amount that includes 25 mol-% or less, 15 mol-% or less, 10 mol-% or less, 5 mol-% or less, 1 mol-% or less, if any, of LiPF₆. In some embodiments, the battery has a total salt amount that includes 1 mol-% to 5 mol-%, 1 mol-% to 10 mol-%, 1 mol-% to 15 mol-%, 1 mol-% to 25 mol-%, 5 mol-% to 10 mol-%, or 5 mol-% to 15 mol-% of LiPF₆, if any.

In some embodiments, the electrolyte includes LiBOB and LiTFSI. In some embodiments, the electrolyte includes LiBOB and LiPF₆. In some embodiments, the electrolyte includes LiBOB, LiTFSI, and LiPF₆. In some embodiments, the electrolyte includes a total salt amount of 0.9 M to 1.5 M where the LiFTSI is present in the highest amount and LiPF₆ is present in an amount that is 25 mol-% or less (if any).

In some embodiments, the electrolyte 50 is a liquid electrolyte. A liquid electrolyte includes a solvent and at least one salt where at least one salt of the at least one salt is LiBOB. Any suitable additional salt or combination of additional salts may be included such as those described elsewhere herein. In some embodiments the solvent is an organic solvent. Examples of suitable organic solvents include linear carbonates such as ethylmethyl carbonate (EMC), ethylene carbonate (EC), dimethyl carbonate (DMC), diethyl carbonate (DEC); ethers such as 1,2,-diethoxyethane (DME); linear carboxylic esters such as methyl formate, methyl acetate, and methyl propionate; nitriles such as acetonitrile; cyclic carbonates such as butylene carbonate (BuC), phenylene carbonate (PeC), hexylene carbonate (HeC), octylene carbonate (OcC), and dodecylene carbonate (DoC); organo sulfur compounds such as sulfolane (SL); and combinations thereof. Organic solvents that have high boiling points tend to have increased viscosities which may result in lower ionic conductivity. As such, in some embodiments, the organic solvent of the electrolyte includes at least one solvent having a boiling point below 140° C. Examples of such solvents include some linear carbonates such as 1,2-diethyoxyethane; some linear carboxylic esters such as methyl formate, methyl acetate, ethyl acetate, and methyl propionate; and some nitriles such as acetonitrile.

In certain embodiments, the organic solvent includes a mixture of ethylene carbonate (EC) and ethylmethyl carbonate (EMC). In certain embodiments, the organic solvent includes a mixture EC and EMC in a range of 10:90 to 50:50. In certain embodiments, the organic solvent includes a mixture of EC and EMC in a ratio of 30:70.

In certain embodiments, the organic solvent includes a mixture of EC, EMC, and sulfolane (SL). In certain embodiments, the organic solvent includes a mixture of EC, EMC and SL in a weight ratio of 20:70:10.

In some embodiments, the electrolyte 50 is a gel electrolyte. A gel electrolyte includes a polymer network that immobilizes a liquid electrolyte containing a solvent and one or more salts where one of the one or more salts is LiBOB. The solvent may be any organic solvent described elsewhere herein. The one or more salts may be any salt or combination of salts described elsewhere herein. The polymer network may include one or more polymers. Examples of suitable polymers include poly(ethylene oxide) and copolymers such as poly(ethylene-propylene oxide); polymers based on the acrylic group such as poly(methyl methacrylate), poly(acrylic acid), lithium poly(acrylate), poly(ethylene glycol diacrylate), and combinations thereof; polymers based on the vinylidene fluoride group such as poly(vinylidene difluoride) (PVdF), copolymers such as poly(vinylidene difluoride-hexafluoropropylene) (PVdF-HFP), and combinations thereof; and combinations thereof.

In some embodiments, the electrolyte includes one or more electrolyte additives. Typically, an electrolyte additive enables a higher voltage operation (e.g., greater than 4.2 V), but can also be used at lower voltages (e.g., less than 4.2 V) and at elevated temperatures (e.g., temperatures greater than 100° C.). The electrolyte additives may include unsaturated compounds such as vinylene carbonate (VC) or vinyl ethylene carbonate (VEC); sulfur-containing compounds such as 1,3-propane sultone (PS), prop-e-ene 1,3-sultone (PES), 1,3,2-dioxthiolane-2-2dioxide (DTD), trimethylene sulfate (TMS), methylene methyl disulfonate (MMDS); boron-containing compounds such as trimethylboroxine and trimethoxyboroxine (TMOBX); phosphorous-containing compounds such as tris(1,1,1,3,3,3-hexafluoro-2-isopropyl)phosphate (HFiP), tris(trimethylsilyl)phosphate (TTSP), tris(trimethylsilyl)phosphite (TTSPi), triallyl phosphate (TAP); aromatic compounds such as biphenyl (BP); heterocyclic compounds such as thiophene (TP); Lewis acid-base adducts such as pyridine-boron trifluoride (PBF); 2,4,6,8-tetramethyl-2,4,6,8-tetravinylcyclotetra-siloxane (ViD4); and mixtures thereof.

The batteries of the present disclosure maintain at least a portion of their capacity after exposure to an elevated temperature (e.g., above 100° C.) as compared to the same battery prior to any exposure to any one of the stated conditions. The term “battery” refers to the complete battery. Exposure of the battery to certain conditions does not include conditions used to make the battery.

In some embodiments, exposure of the battery to an elevated temperature includes exposing the battery to a series of elevated temperatures to reach a maximum elevated temperature. Exposure of the battery to an elevated temperature may include a series of elevated temperatures to reach room temperature and/or application temperature. In such cases, the maximum temperature of exposure is considered the elevated temperature.

In some embodiments, the batteries of the present disclosure retain at least a major portion of their capacity as compared to the same battery prior to any exposure to an elevated temperature after repeated cycles. For the sake of clarity of the present disclosure, the term “cycle” refers to combination of one electrochemical cycle and one thermal cycle. In practice, the battery may be subjected to multiple electrochemical cycles prior to a single thermal cycle and vice versa. An electrochemical cycle includes discharging the battery to first state of charge (SOC) and charging the same battery to a second SOC. An electrochemical cycle may include charging the battery to an SOC of 50% or greater, 75% or greater, 80% or greater, 90% or greater, or 95% or greater, and up to 100%. An electrochemical cycle may include discharging the battery to an SOC of 100% or less, 95% or less, 90% or less, 75% or less, 50% or less, 25% or less, or 10% or less, and down to 0%. During a thermal cycle, the battery is exposed to conditions that include and elevated temperature for an exposure time. Sequential cycles may include different charging and discharging SOCs, different elevated temperature for the same and/or different exposure times or the same elevated temperature for the same and/or different exposure time. In some embodiments, an electrochemical cycle and thermal cycle may overlap in that the exposure to an elevated temperature may occur during use (during the electrochemical cycle).

According to an embodiment, the battery retains at least 50% (e.g., 50% to 100%), at least 80% (e.g., 80% to 100%), at least 90% (e.g., 90% to 100%), at least 95% (e.g., 95% to 100%), or at least 98% (e.g., 98% to 100%) of its capacity after exposure to a plurality of thermal cycles. A thermal cycle exposes the battery to elevated temperature conditions. The elevated temperature conditions of a thermal cycle may include exposure to an elevated temperature of 100° C. or greater, 121° C. or greater, 135° C. or greater, or 140° C. or greater, and up to 200° C. (e.g., 100° C., 121° C., 135° C., 140° C., 100° C. to 200° C., 100° C. to 121° C., 100° C. to 135° C., or 135° C. to 200° C.) for a time period of 1 minute (min) or greater, 4 min or greater, 12 min or greater, 18 min or greater, 20 min or greater, 30 min or greater, 90 min or greater, 120 min or greater, or 180 min or greater, and up to 360 min (e.g., 1 min to 360 min, 4 min to 360 min, 4 min to 180 min, 12 min to 120 min, 12 min to 18 min, 18 min to 30 min, 18 min to 90 min, 18 min to 120 min, 18 min to 180 min, 20 min to 90 min, 20 min to 30 min, or 30 min to 90 min). In some embodiments, the plurality of thermal cycles is 4 or more, 5 or more, 10 or more, 50 or more, 100 or more, 200 or more, or 300 or more, and up to 500 thermal cycles (e.g., 5 to 500, 5 to 300, 5 to 200, 5 to 100, 50 to 200, 110 to 200, 100 to 300, or 100 to 500 thermal cycles).

The present disclosure includes methods of exposing the batteries of the present disclosure to conditions that include an elevated temperature. The battery may be any battery and have any property as described herein. The heating method 100 includes charging or discharging the battery at application temperature 110 and exposing the battery to a condition that includes a temperature of 100° C. or greater for one minute or more 120. Such a method may be a sterilization method, for example, conditions that are a part of an autoclaving cycle.

Discharging or charging the battery at the application temperature 110 may include discharging or charging the battery to a state of charge (SOC) of 0% to 100%. For example, in some embodiments, the battery is discharged to a SOC of less than 100% through use in a tool/device at the application temperature. In some embodiments, the battery is discharged to a SOC of less than 100% and then subsequently charged to regain at least a portion of the capacity to which it was discharged. In some embodiments, the battery is discharge and/or charged to an SOC of at least 20%, at least 50%, at least 75%. In some embodiments, the battery is discharge and/or charged to an SOC of 100% or less, 75% or less, or 50% or less. In some embodiments, the battery is discharge and/or charged to an SOC of 20% to 100%, 20% to 75%, or 20% to 50%. In some embodiments, the battery is discharge and/or charged to an SOC of 50% to 100% or 50% to 75%. In some embodiments, the battery is discharge and/or charged to an SOC of 50% to 75%. In some embodiments, the battery is completely discharged and not recharged, and thereby has an SOC of 0%.

In some embodiments, exposing the battery to a condition that includes an elevated temperature (e.g., 100° C. or greater) 120, includes exposing the battery to an elevated temperature for a period of time. In some embodiments, exposing the battery to a condition that includes an elevated temperature may include exposing the battery to a series of elevated temperatures to reach a maximum elevated temperature and a series of elevated temperatures to reach room temperature and/or application temperature.

In some embodiments, exposing the battery to a condition that includes and elevated temperature for a period of time includes exposing the battery to a temperature of 100° C. or greater, 121° C. or greater, 135° C. or greater, or 140° C. or greater, and up to 200° C. (e.g., 100° C. to 200° C., 100° C. to 140° C., 100° C. to 135° C., 100° C. to 121° C., 121° C. to 200° C., 121° C. to 140° C., 121° C. to 135° C., 135° C. to 200° C., 135° C. to 140° C., or 140° C. to 200° C.) for a time period of at least 1 min, at least 4 min, at least 12 min, at least 18 min, at least 20 min, at least 30 min, at least 90 min, at least 120 min, at least 180 min, and up to 360 min (e.g., 1 min to 360 min, 1 min to 180 min, 1 min to 120 min, 1 min to 90 min, 1 min to 30 min, 1 min to 20 min, 1 min to 18 min, 1 min to 12 min, 1 min to 4 min, 4 min to 360 min, 4 min to 180 min, 4 min to 120 min, 4 min to 90 min, 4 min to 30 min, 4 min to 20 min, 4 min to 18 min, 4 min to 12 min, 12 min to 360 min, 12 min to 180 min, 12 min to 120 min, 12 min to 90 min, 12 min to 30 min, 12 min to 20 min, 12 min to 18 min, 18 min to 360 min, 18 min to 180 min, 18 min to 120 min, 18 min to 90 min, 18 min to 30 min, 20 min to 360 min, 20 min to 180 min, 20 min to 120 min, 20 min to 90 min, 20 min to 30 min, 90 min to 360 min, 90 min to 180 min, 90 min to 120 min, 120 min to 360 min, or 120 min to 180 min).

In some embodiments, the method of heating 100 further includes cooling the battery to room temperature, application temperature, and/or a storage temperature. Cooling may be accomplished by exposing the battery to the desired temperature for a period of time. Cooling may be accomplished by exposing the battery to a temperature below the desired temperature in order to rapidly cool the battery to the desired temperature.

In some embodiments, the method of heating 100 further includes repeating the method using the same battery for a number of cycles. A cycle includes the method of heating 100 and cooling the battery to room temperature and/or application temperature. In some embodiments, the method is repeated for 5 or more, 10 or more, 50 or more, 100 or more, 200 or more, or 300 or more, and up to 500 cycles (e.g., 5 to 500, 5 to 300, 5 to 200, 5 to 100, 5 to 50, 5 to 10, 10 to 500, 10 to 300, 10 to 200, 10 to 100, 10 to 50, 50 to 500, 50 to 300, 50 to 200, 50 to 100, 100 to 500, 100 to 300, 100 to 200, 200 to 500, 200 to 300, or 300 to 500 cycles).

The present disclosure also describes methods of making the batteries of the present disclosure. The battery may be any battery of the present disclosure and have any property as described herein.

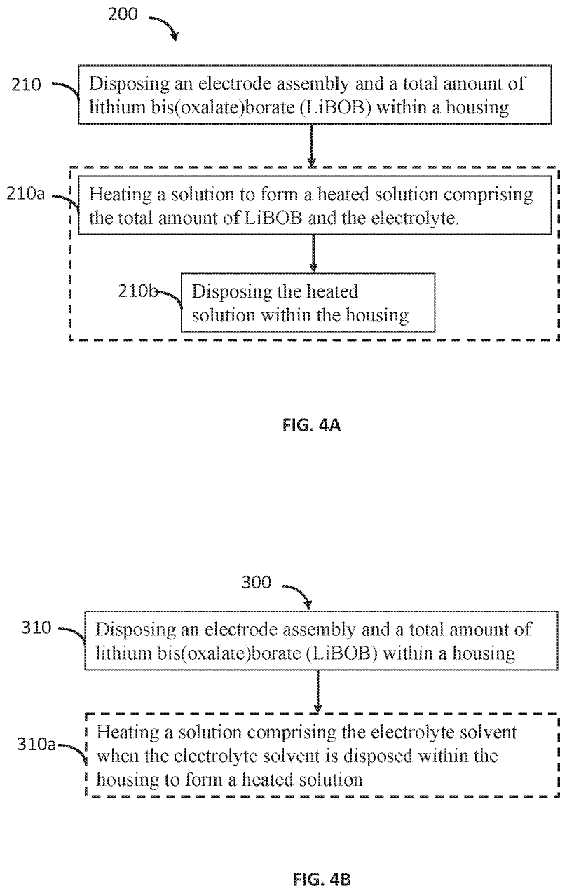

A first illustrative method 200 of making the battery and a second illustrative method 300 of making the battery, both include disposing an electrode assembly and a total amount of LiBOB within a housing 210/310. The methods 200, 300 are illustrated in FIGS. 4A and 4B.

In the first method 200 of making a battery, disposing the electrode assembly and total amount of LiBOB within a housing includes placing all the components of the battery except the electrolyte components (e.g., electrolyte solvent, one or more salts (if used), one or more additives (if used)) and the total amount of LiBOB within a housing. The method may further include heating a mixture of all the components of the electrolyte (e.g., electrolyte solvent, one or more salts (if used), one or more additives (if used)) and the total amount of LiBOB to create a heated solution such that all the components of the electrolyte and the total amount of LiBOB are dissolved in the heated solution 210a. The method may further include disposing the heated solution into the housing 210b. The method may further include sealing, such as hermetically sealing, the battery. Sealing of the battery may be accomplished prior to or after cooling the battery that includes the heated solution to room temperature, application temperature, and/or the storage temperature.

In a second method 300 of making a battery, disposing the electrode assembly and total amount of LiBOB within a housing includes placing the anode, the cathode, the separator, and a solution within a housing. The solution includes the electrolyte solvent. The solution may include the total amount of LiBOB, a portion of the total amount of LiBOB, or none of the total amount of LiBOB. The solution may include none, some, or all of the components of the desired electrolyte (e.g., one or more additional salts (if used) and/or one or more electrolyte additives (if used)). For example, in some embodiments, the solution includes all of the one or more additional salts (if used) except the total amount of LiBOB, and any electrolyte additives (if used). In some embodiments, the solution includes a portion of the total amount of LiBOB, all of the one or more additional salts (if used), and any electrolyte additives (if used). In some embodiments, the solution includes a portion of the total amount of LiBOB, all of the one or more additional salts (if used), and any electrolyte additives (if used). In some embodiments the solution includes the total amount of the electrolyte solvent. In some embodiments, the solution includes a portion of the total amount of the electrolyte solvent.

In some embodiments, the second method 300 further includes heating the housing such as to heat the solution, creating a heated solution, to a temperature that will allow for the dissolution of the total amount of LiBOB. In such embodiments, the method may further include adding the components of the desired electrolyte that are not already present in the solution and the total amount of LiBOB to the heated solution. In some embodiments, the electrolyte components and/or the total amount of LiBOB may be added as solids. In some embodiments, the electrolyte components and/or the total amount of LiBOB may be added as a premade solution that includes a portion of the electrolyte solvent. For example, in some embodiments, the total amount of LiBOB may be added as a solid or added as supersaturated solution in the electrolyte solvent. In some embodiments, the method further includes agitating and/or stirring the mixture to facilitate dissolution of the total amount of LiBOB and/or any other components of the electrolyte. The method may further include sealing, such as hermetically sealing, the battery. Sealing of the battery may be accomplished prior to or after cooling the battery that includes the heated solution to room temperature, application temperature, or the storage temperature.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

### EXAMPLES

### Example 1

Lithium ion cells of 100 mAh nominal capacity were constructed as spirally wound prismatic cells in a stainless steel enclosure that was hermetically sealed and used a glass feedthrough. The positive electrodes were comprised of LiNi_{0.88}Co_{0.10}Al_{0.2}O₂ (Grade HKS-17R from Hunan ShanShan Energy Co. Ltd. in Changsha City, China) positive active material coated onto a carbon-coated aluminum current collector. The negative electrodes were comprised of spherical natural graphite (Grade M11C from Posco in Pohang-si, South Korea) negative active material coated onto a copper current collector. The positive and negative electrodes were prepared using a slurry coating and calendaring process. Both electrodes included their respective active materials described above, a conductive carbon diluent, and a polymeric PVDF binder. The cells were filled with 1.5±0.1 g of electrolyte, the composition of which is described in Table 1. The electrolytes (salts+solvents) for cells 1, 2, and 3 were mixed at room temperature, while the electrolyte from Sample 4 was heated to approximately 70° C. in order to dissolve additional LiBOB above the room temperature solubility limit.

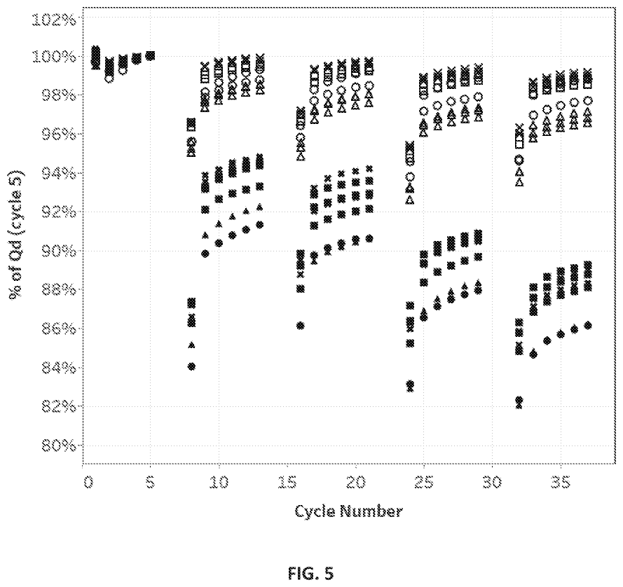

TABLE 1

| Cell group | Total Salt Blend | Solvent Blend | Separator | Symbol in FIG. 5 |
|---|---|---|---|---|
| 1 | 0.9M LiTFSI + | EC:EMC 3:7 | DW Silver 25 | Circle |
| | 0.15M LiBOB + | | | |
| | 0.05M LiPF6 | | | |
| 2 | 0.9M LiTFSI + | EC:SL:EMC | DW Gold 20 | Triangle |
| | 0.15M LiBOB + | 2.7:1.0:6.3 | | |
| | 0.05M LiPF6 | | | |
| 3 | 0.9M LiTFSI + | EC:EMC 3:7 | DW Silver 25 | Square |
| | 0.25M LiBOB + | | | |
| | 0.05M LiPF6 | | | |
| 4 | 0.6M LiTFSI + | EC:EMC 3:7 | DW Gold 20 | Cross |
| | 0.45M LiBOB + | | | |
| | 0.05M LiPF6 | | | |

For cells 1 and 3 the separator was a 25 μm nanofiber membrane with a degradation temperature of 300° C. sold under the tradename of Dreamweaver SILVER25 (from Dreamweaver International in Greer, SC); while for cells 2 and 4 the separator was a 20 μm TWARON aramid nanofiber membrane with degradation temperature of approximately 450° C., sold under the tradename of Dreamweaver GOLD20 (from Dreamweaver International in Greer, SC).

Within 24 hours of filling the cells with electrolyte and sealing the cells, the cells were put through a formation protocol at an application temperature of 25° C.±1° C., described by:
1. Constant current (CC) charge at a rate of 0.1 C (current of 10 mA) to an upper cutoff voltage of 4.1 V
2. Constant voltage (CV) hold at 4.1 V for 4 hours
3. Open circuit storage for 30 hours
4. CC discharge at a rate of 0.1 C (current of 10 mA) to a lower cutoff voltage of 2.8 V
5. Open circuit storage for 10 minutes
6. CC charge at a rate of 0.1C (current of 10 mA) to an upper cutoff voltage of 4.1 V
7. CV hold at 4.1 V for 1 hour
8. Open circuit storage for a minimum of 1 hour

Once the formation protocol was complete, all cells proceeded through an electrochemical performance test at an application temperature of 25° C.±1° C., described by:
5 CC-CV charge—CC discharge cycles of 0.5 C (50 mA) CC charge to 4.1 V with a CV hold at 4.1 V until the current was less than or equal to 10 mA, and 0.5 C (50 mA) CC discharge to 2.8 V
1 CC-CV charge—CC discharge cycles of 0.1 C (10 mA) CC charge to 4.1 V with a CV hold at 4.1 V until the current was less than or equal to 5 mA, and 0.1 C (10 mA) CC discharge to 2.8 V
1 CC-CV charge—CC+DCIR pulse cycles of 0.1 C (10 mA) CC charge to 4.1 V with a CV hold at 4.1 V until the current was less than or equal to 5 mA, and 0.1 C (10 mA) CC background current draw with 5 second 2 W pulses done at 4.1 V, 3.7 V, and 3.5 V.
1 CC charge at 0.5 C (50 mA) to 4.1 V with a CV hold at 4.1 V until the current was less than or equal to 10 mA.

Following the electrochemical performance test described above, the cells were divided into two groups: one control group and one exposed group. All cells were at 100% state of charge. The control group remained at room temperature while the exposed group cells were placed in a benchtop steam autoclave (Tuttnauer EZ9) with a sterilization dwell setting of 125° C. for 18 minutes. A linear ramp and dry profile was used with an approximate 20 minute ramp time. Following the autoclave sterilization cycle, both the control and the exposed cells were discharged to 2.8 V at 0.5 C (50 mA) and then proceeded through the same electrochemical performance test at application temperature described above. This was repeated three more times for a total of four autoclave exposures.

FIG. 5 shows the measured the 0.5 C discharge capacity normalized to the 0.5 C discharge capacity measured for cycle number 5 for the control groups (open symbols) and the exposed groups (closed symbols) of cells 1 through 4 as defined in Table 1. After the first autoclave exposure, the group with the highest remaining capacity was cell 4, where the electrolyte was formulated with 0.45 M LiBOB. The room temperature solubility limit of LiBOB in the carbonate solvent blend is approximately 0.25-0.3 M, therefore cell represents a case where there is a reservoir of excess LiBOB when operating at room temperature. Cell 3, where the electrolyte was formulated with 0.25 M LiBOB, represents the room temperature solubility limit. In comparison to the cells 1 and 2 which both contain only 0.15 M LiBOB, the cells with the higher LiBOB concentration retain a greater fraction of their capacity following autoclave exposure. Following the first autoclave exposure, the remaining 0.5 C discharge capacity at cycle number 13 is tabulated in Table 2, and highlights the benefit of the additional LiBOB reservoir.

TABLE 2

| | | Average recoverable 0.5 C discharge |
|---|---|---|
| Cell group | Total Salt Blend | capacity following autoclave exposure |
| 1 | 0.9M LiTFSI + | 91.3% |
| | 0.15M LiBOB + | |
| | 0.05M LiPF6 | |
| 2 | 0.9M LiTFSI + | 92.3% |
| | 0.15M LiBOB + | |
| | 0.05M LiPF6 | |
| 3 | 0.9M LiTFSI + | 94.0% |
| | 0.25M LiBOB + | |
| | 0.05M LiPF6 | |
| 4 | 0.6M LiTFSI + | 94.7% |
| | 0.45M LiBOB + | |
| | 0.05M LiPF6 | |

Example 1. A battery comprising: a housing; a total amount of lithium bis(oxalate)borate (LiBOB) disposed within the housing, the total amount of LiBOB such that a first amount of LiBOB is solid and a second amount of LiBOB is dissolved in an electrolyte when the battery is at application temperature; an electrode assembly disposed within the housing, the electrode assembly comprising: a positive electrode; a negative electrode; a separator comprising a material having a degradation temperature greater than 120° C.; and the electrolyte comprising: an organic solvent; and the second amount of LiBOB; and a LiBOB reservoir comprising the first amount of LiBOB, the battery being capable of retaining 50% or more of its capacity upon exposure to a temperature of 100° C. or greater.
Example 2. The battery of Example 1, wherein the battery is capable of retaining 80% or more of its capacity upon exposure to a temperature of 100° C. or greater.
Example 3. The battery of Example 1 or Example 2, wherein the total amount of lithium bis(oxalato)borate is 0.1 M to 0.8 M.
Example 4. The battery of any one of Examples 1 to 3, wherein the electrolyte further comprises one or more additional salts and wherein a total concentration of the one or more additional salts and the total amount of lithium bis(oxalato)borate is at least 0.11 M to 6 M.
Example 5. The battery of Example 4, wherein the one or more additional salts comprise lithium bis(trifluoromethanesulfonimide) (LiTFSI), lithium bis(pentafluoroethyl sulfonyl)imide (LiBETI), lithium bis(fluorosulfonyl)imide (LiFSI), lithium difluoro(oxalate)borate (LiDFOB), lithium tetrafluoroborate (LiBF₄), lithium trifluoromethanesulfonate (Li Triflate), lithium hexafluoroarsenate (LiAsF₆), lithium hexafluorophosphate (LiPF₆), or combinations thereof.
Example 6. The battery of Example 5, wherein the electrolyte comprises LiPF₆ in an amount of no greater than 25 mol-%.
Example 7. The battery of any one of Examples 1 to 6, wherein the organic solvent comprises a linear carbonate, a cyclic carbonate, an organosulfur compound, or combinations thereof.
Example 8. The battery of any one of Examples 1 to 7, wherein the battery is a lithium-ion battery.
Example 9. A method of sterilizing a battery, the method comprising: charging or discharging the battery to a state of charge of 20% to 100% at application temperature, the battery comprising: a housing; a total amount of lithium bis(oxalate)borate (LiBOB) disposed within the housing, the total amount of LiBOB such that a first amount of LiBOB is solid and a second amount of LiBOB is dissolved in an electrolyte when the battery is at application temperature; an electrode assembly disposed within the housing, the electrode assembly comprising: a positive electrode; a negative electrode; a separator comprising a material having a degradation temperature greater than 120° C.; the electrolyte comprising: an organic solvent; and the second amount of LiBOB; and a LiBOB reservoir comprising the first amount of LiBOB; and exposing the battery to a condition comprising a temperature of 100° C. or more for four minutes or more, wherein upon exposing the battery to the condition, the first amount of LiBOB decreases and the second amount of LiBOB increases, and the battery being capable of retaining 50% or more of its capacity at application temperature upon exposure to the condition.
Example 10. The method of Example 9, wherein the condition comprises a temperature of 125° C. to 145° C. for five to 60 minutes, and wherein the battery is capable of retaining 80% or more of its capacity at application temperature.
Example 11. The method of Example 9 or 10, wherein the method is repeated 2 to 300 times.
Example 12. The method of any one of Examples 9 to 11, wherein the total amount of LiBOB is at least 0.1 M to 0.8 M.
Example 13. The method of any one of Examples 9 to 12, wherein the battery is a lithium-ion battery.
Example 14. The method of any one of Examples 9 to 13, wherein the electrolyte further comprises one or more additional salts and wherein the total concentration of the one or more additional salts and the total amount of LiBOB is 0.11 M to 6 M.
Example 15. A method of forming a battery, the method comprising: disposing an electrode assembly and a total amount of lithium bis(oxalate)borate (LiBOB) within a housing: the resultant battery comprising the housing; the total amount of LiBOB such that a first amount of LiBOB is solid and a second amount of LiBOB is dissolved in an electrolyte when the battery is at application temperature; the electrode assembly disposed within the housing, the electrode assembly comprising: a positive electrode; a negative electrode; a separator comprising a material having a degradation temperature greater than 120° C.; and the electrolyte comprising: an organic solvent; and the second amount of LiBOB; and a LiBOB reservoir comprising the first amount of LiBOB, the battery being capable of retaining 50% or more of its capacity upon exposure to a temperature of 100° C. or greater.
Example 16. The method of Example 15, further comprising heating a solution to give a heated solution, the solution comprising the total amount of lithium bis(oxalate)borate, the organic solvent and the electrolyte.
Example 17. The method of Example 16, wherein the solution is heated when disposed within the housing.
Example 18. The method of Example 16, wherein the solution is heated external to the housing and wherein the method further comprises, disposing the heated solution into the housing.
Example 19. The method of any one of Examples 15 to 18, wherein the total amount of LiBOB is 0.1 M to 0.8 M.
Example 20. The battery of any one of Examples 1 to 8, wherein the electrolyte further comprises one or more additional salts and wherein a total concentration of the one or more additional salts and the total amount of LiBOB is at least 0.1 M to 6 M.

1. A battery comprising:
a housing;
a total amount of lithium bis(oxalate)borate (LiBOB) disposed within the housing, the total amount of LiBOB such that a first amount of LiBOB is solid and a second amount of LiBOB is dissolved in an electrolyte when the battery is at application temperature;
an electrode assembly disposed within the housing, the electrode assembly comprising:
a positive electrode;
a negative electrode;
a separator comprising a material having a degradation temperature greater than 120° C.; and
the electrolyte comprising:
an organic solvent; and
the second amount of LiBOB; and
a LiBOB reservoir comprising the first amount of LiBOB,
the battery being capable of retaining 50% or more of its capacity upon exposure to a temperature of 100° C. or greater.

2. The battery of claim 1, wherein the battery is capable of retaining 80% or more of its capacity upon exposure to a temperature of 100° C. or greater.

3. The battery of claim 1, wherein the total amount of lithium bis(oxalato)borate is 0.1 M to 0.8 M.

4. The battery of claim 1, wherein the electrolyte further comprises one or more additional salts and wherein a total concentration of the one or more additional salts and the total amount of lithium bis(oxalato)borate is at least 0.11 M to 6 M, and wherein the one or more additional salts comprise lithium bis(trifluoromethanesulfonimide) (LiTFSI), lithium bis(pentafluoroethyl sulfonyl)imide (LiBETI), lithium bis(fluorosulfonyl)imide (LiFSI), lithium difluoro(oxalate)borate (LiDFOB), lithium tetrafluoroborate (LiBF₄), lithium trifluoromethanesulfonate (Li Triflate), lithium hexafluoroarsenate (LiAsF₆), lithium hexafluorophosphate (LiPF₆), or combinations thereof.

5. The battery of claim 4, wherein the electrolyte comprises LiPF₆ in an amount of no greater than 25 mol-%.

6. The battery of claim 1, wherein the battery is a lithium-ion battery.

7. A method of sterilizing a battery, the method comprising:
charging or discharging the battery to a state of charge of 20% to 100% at application temperature, the battery comprising:
a housing;
a total amount of lithium bis(oxalate)borate (LiBOB) disposed within the housing, the total amount of LiBOB such that a first amount of LiBOB is solid and a second amount of LiBOB is dissolved in an electrolyte when the battery is at application temperature;
an electrode assembly disposed within the housing, the electrode assembly comprising:
a positive electrode;
a negative electrode;
a separator comprising a material having a degradation temperature greater than 120° C.;
the electrolyte comprising:
an organic solvent; and
the second amount of LiBOB; and
a LiBOB reservoir comprising the first amount of LiBOB; and
exposing the battery to a condition comprising a temperature of 100° C. or more for four minutes or more, wherein upon exposing the battery to the condition, the first amount of LiBOB decreases and the second amount of LiBOB increases, and
the battery being capable of retaining 50% or more of its capacity at application temperature upon exposure to the condition.

8. The method of claim 7, wherein the condition comprises a temperature of 125° C. to 145° C. for five to 60 minutes, and wherein the battery is capable of retaining 80% or more of its capacity at application temperature.

9. The method of claim 7, wherein the method is repeated 2 to 300 times.

10. The method of claim 7, wherein the total amount of LiBOB is at least 0.1 M to 0.8 M.

11. The method of claim 7, wherein the electrolyte further comprises one or more additional salts and wherein the total concentration of the one or more additional salts and the total amount of LiBOB is 0.11 M to 6 M.

12. A method of forming a battery, the method comprising:
disposing an electrode assembly and a total amount of lithium bis(oxalate)borate (LiBOB) within a housing:
the resultant battery comprising
the housing;
the total amount of LiBOB such that a first amount of LiBOB is solid and a second amount of LiBOB is dissolved in an electrolyte when the battery is at application temperature;
the electrode assembly disposed within the housing, the electrode assembly comprising:
a positive electrode;
a negative electrode;
a separator comprising a material having a degradation temperature greater than 120° C.; and
the electrolyte comprising:
an organic solvent; and
the second amount of LiBOB; and
a LiBOB reservoir comprising the first amount of LiBOB,
the battery being capable of retaining 50% or more of its capacity upon exposure to a temperature of 100° C. or greater.

13. The method of claim 12, further comprising heating a solution to give a heated solution, the solution comprising the total amount of lithium bis(oxalate)borate, the organic solvent and the electrolyte.

14. The method of claim 13, wherein the solution is heated when disposed within the housing or wherein the solution is heated external to the housing and wherein the method further comprises, disposing the heated solution into the housing.

15. The method of claim 12, wherein the total amount of LiBOB is 0.1 M to 0.8 M.
